(19) United States
(12) Patent Application Publication
(10) Pub. No.: US 2008/0003483 A1
(43) Pub. Date: Jan. 3, 2008

(54) Fuel cell

(75) Inventors: Tadashi Tsunoda, Nerima-ku (JP); Tomio Miyazaki, Suginami-ku (JP)

Correspondence Address: LAHIVE & COCKFIELD, LLP, ONE POST OFFICE SQUARE, BOSTON, MA, 02109-2127, US

(73) Assignee: Honda Motor Co., Ltd., Tokyo (JP)

(21) Appl. No.: 11/700,302

(22) Filed: Jan. 31, 2007

(30) Foreign Application Priority Data
Jan. 31, 2006 (JP) 2006-023050

(51) Int. Cl. H01M 8/08

(52) U.S. Cl. 429/34

(57) ABSTRACT

A fuel cell includes a fuel gas channel formed between a separator and an anode, a fuel gas supply passage for allowing a fuel gas to flow in a stacking direction, and a fuel gas supply channel for supplying the fuel gas from the fuel gas supply passage to the fuel gas channel. The fuel gas supply channel extends along a surface of the separator. A branch channel is branched from the fuel gas supply passage along the separator surface, and connected to the fuel gas supply channel thorough holes extending in a stacking direction.

### BACKGROUND OF THE INVENTION

1. Field of the Invention

The present invention relates to a fuel cell formed by stacking an electrolyte electrode assembly and a separator. The electrolyte electrode assembly includes an anode, a cathode, and an electrolyte interposed between the anode and the cathode.

2. Description of the Related Art

Typically, a solid oxide fuel cell (SOFC) employs an electrolyte of ion-conductive solid oxide such as stabilized zirconia. The electrolyte is interposed between an anode and a cathode to form an electrolyte electrode assembly. The electrolyte electrode assembly is interposed between separators (bipolar plates). In practical use, the predetermined number of the electrolyte electrode assemblies and the separators are stacked together to form a fuel cell stack.

In the fuel cell, in order to supply a fuel gas such as a hydrogen-containing gas and an oxygen-containing gas such as the air to the anode and the cathode, respectively, a fuel gas channel and an oxygen-containing gas channel are formed along separator surfaces. The fuel cell stack may have internal manifold structure in which a fuel gas supply unit and an oxygen-containing gas supply unit extend in the stacking direction for distributing the fuel gas and the oxygen-containing gas to the fuel gas channel and the oxygen-containing gas channel, respectively.

For example, as shown in FIG. 24, a solid oxide fuel cell disclosed in Japanese Laid-Open Patent Publication No. 9-231987 has a composite separator including a main body 1, a current collector 2, and a plurality of lid members 3. A plurality of gas grooves 2a and ridges 2b are arranged alternately in the current collector 2.

At four corners of the composite separator, gas supply/discharge holes 4a are formed. Two of the gas supply/discharge holes 4a at ends of one diagonal line are air holes, and the other two gas supply/discharge holes 4b at ends of the other diagonal line are fuel gas holes. Recesses (branch channels) 5 connected to the gas supply/discharge holes 4a are provided on one surface of the body 1, and a cutout groove 6 connected to the recess 5 is formed in the lid member 3.

For example, the oxygen-containing gas which flows in the stacking direction along one of the supply/discharge holes 4a is branched from the one supply/discharge hole 4a into one of the recesses 5, and supplied to the gas grooves 2a of the current collector 2 through the cutout groove 6 of the lid member 3. Then, the consumed oxygen-containing gas is discharged from the other recess 5 to the other supply/discharge hole 4a, and flows in the stacking direction.

However, in the above technique, since the recesses 5 are provided along the surface of the body 1 in a relatively large area, the shapes of the openings of the branch channels formed by the recesses 5 are deformed easily when a load in the stacking direction is applied to the composite separator. Thus, the flow rate control of the oxygen-containing gas and the fuel gas cannot be performed accurately, and the desired power generation performance cannot be achieved. Further, since grooves such as the recesses 5 or the like in the body 1 need to be fabricated, high fabrication cost is uneconomically required in production.

### SUMMARY OF THE INVENTION

The present invention has been made to solve the problems, and an object of the present invention is to provide a fuel cell having simple and economical structure in which it is possible to supply reactant gases uniformly to electrode surfaces of electrolyte electrode assemblies, and achieve uniform power generation reaction.

The present invention relates to a fuel cell formed by stacking an electrolyte electrode assembly and a separator. The electrolyte electrode assembly includes an anode, a cathode, and an electrolyte interposed between the anode and the cathode. The fuel cell comprises a fuel gas channel provided on one surface of the separator for supplying a fuel gas along a surface of the anode, an oxygen-containing gas channel provided on the other surface of the separator for supplying an oxygen-containing gas along a surface of the cathode, a fuel gas supply channel extending along a separator surface to intersect a stacking direction for supplying the fuel gas from a fuel gas supply unit which allows the fuel gas to flow in the stacking direction, to the fuel gas channel, a branch channel branched from the fuel gas supply unit toward the separator surface, and a hole connecting the branch channel and the fuel gas supply channel in the stacking direction.

Further, according to another aspect of the present invention, the fuel cell comprises a fuel gas channel provided on one surface of the separator for supplying a fuel gas along a surface of the anode, an oxygen-containing gas channel provided on the other surface of the separator for supplying an oxygen-containing gas along a surface of the cathode, an oxygen-containing gas supply channel extending to the oxygen-containing gas channel along a separator surface to intersect a stacking direction for supplying the oxygen-containing gas from an oxygen-containing gas supply unit which allows the oxygen-containing gas to flow in the stacking direction, a branch channel branched from the oxygen-containing gas supply unit toward the separator surface, and a hole connecting the branch channel and the oxygen-containing gas supply channel in the stacking direction.

Preferably, a first seal is provided at the branch channel around the hole for sealing the fuel gas supply unit from the electrolyte electrode assembly. Further, preferably, a second seal is provided for sealing the fuel gas supply unit from the fuel gas supply channel, and the hole is provided between the first seal and the second seal.

Preferably, a second seal is provided for sealing the fuel gas supply unit from the fuel gas supply channel, and the hole is formed in the first seal. Further, preferably, a first seal is provided at the branch channel around the hole for sealing the oxygen-containing gas supply unit from the electrolyte electrode assembly. Further, preferably, a second seal is provided for sealing the oxygen-containing gas supply unit from the oxygen-containing gas supply channel, and the hole is provided between the first seal and the second seal.

Further, preferably, a second seal is provided for sealing the oxygen-containing gas supply unit from the oxygen-containing gas supply channel, and the hole is formed in the first seal.

Further, preferably, first protrusions forming the fuel gas channel or a deformable elastic channel member forming the fuel gas channel, and tightly contacts the anode is formed on one surface of the separator, second protrusions forming the oxygen-containing gas channel or a deformable elastic channel member forming the oxygen-containing gas channel, and tightly contacts the cathode is formed on the other surface of the separator, and a fuel gas channel member forming the fuel gas supply channel is provided on one surface or the other surface of the separator.

Preferably, the separator comprises a single plate, the first seal includes a seal member provided between a pair of the separators, and the second seal includes a protrusion provided in the separator or the fuel gas channel member. Further, preferably, the hole is formed in the separator or the fuel gas channel member.

Further, preferably, the separator includes first to third plates which are stacked together, the fuel gas channel is formed between the first plate and the anode, the oxygen-containing gas channel is formed between the third plate and the cathode, the fuel gas supply channel is formed between the first plate and the second plate, and the oxygen-containing gas supply channel is formed between the third plate and the second plate.

Preferably, the hole is formed in the first plate or the second plate, and the second seal is provided in the first plate or the second plate. Further, preferably, the hole is formed in the second plate or the third plate, and the second seal is provided in the second plate or the third plate.

According to the present invention, the hole connecting the branch channel branched from the fuel gas supply unit and the fuel gas supply channel connected to the fuel gas channel extend through the fuel cell in the stacking direction. Further, the hole connecting the branch channel branched from the oxygen-containing gas supply unit and the oxygen-containing gas supply channel connected to the oxygen-containing gas channel extends through the fuel cell in the stacking direction.

In the structure, when a tightening load is applied to the fuel cell in the stacking direction, it is possible to reliably supply the fuel gas and the oxygen-containing gas to the stacked electrolyte electrode assemblies at a certain flow rate without causing deformation of the holes. With simple and economical structure, uniform power generation reaction is achieved, and the power generation efficiency is improved.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view schematically showing a fuel cell stack formed by stacking fuel cells according to a first embodiment of the present invention;

FIG. 2 is an exploded perspective view showing the fuel cell;

FIG. 3 is a partial exploded perspective view showing gas flows in the fuel cell;

FIG. 4 is a view showing a separator;

FIG. 5 is a cross sectional view schematically showing operation of the fuel cell;

FIG. 6 is an exploded perspective view showing a fuel cell according to a second embodiment of the present invention;

FIG. 7 is a front view showing a separator of the fuel cell;

FIG. 8 is a cross sectional view schematically showing operation of the fuel cell;

FIG. 9 is an exploded perspective view showing a fuel cell according to a third embodiment of the present invention;

FIG. 10 is a cross sectional view schematically showing operation of the fuel cell;

FIG. 11 is an exploded perspective view showing a fuel cell according to a fourth embodiment of the present invention;

FIG. 12 is a cross sectional view schematically showing operation of the fuel cell;

FIG. 13 is perspective view schematically showing a fuel cell stack formed by stacking fuel cells according to a fifth embodiment of the present invention;

FIG. 14 is an exploded perspective view showing the fuel cell;

FIG. 15 is a partial exploded perspective view showing gas flows in the fuel cell;

FIG. 16 is a cross sectional view schematically showing operation of the fuel cell;

FIG. 17 is a perspective view schematically showing a fuel cell stack formed by stacking fuel cells according to a sixth embodiment of the present invention;

FIG. 18 is an exploded perspective view showing the fuel cell;

FIG. 19 is a cross sectional view showing operation of the fuel cell;

FIG. 20 is a cross sectional view schematically showing operation of a fuel cell according to a seventh embodiment of the present invention;

FIG. 21 is a cross sectional view showing the fuel cell taken along a line XXI-XXI in FIG. 20;

FIG. 22 is a cross sectional view schematically showing operation of the fuel cell according to an eighth embodiment of the present invention;

FIG. 23 is a cross sectional view schematically showing operation of the fuel cell according to a ninth embodiment of the present invention; and

FIG. 24 is a view showing a conventional fuel cell.

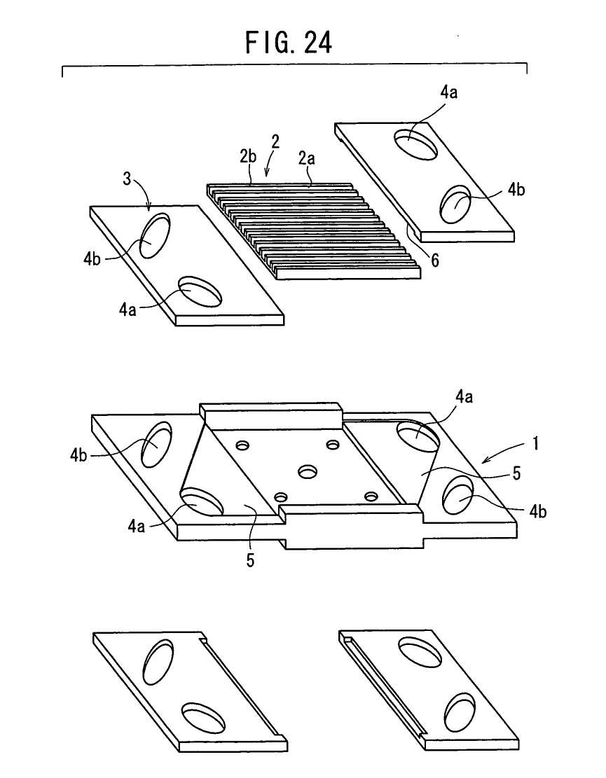

### DESCRIPTION OF THE PREFERRED EMBODIMENTS

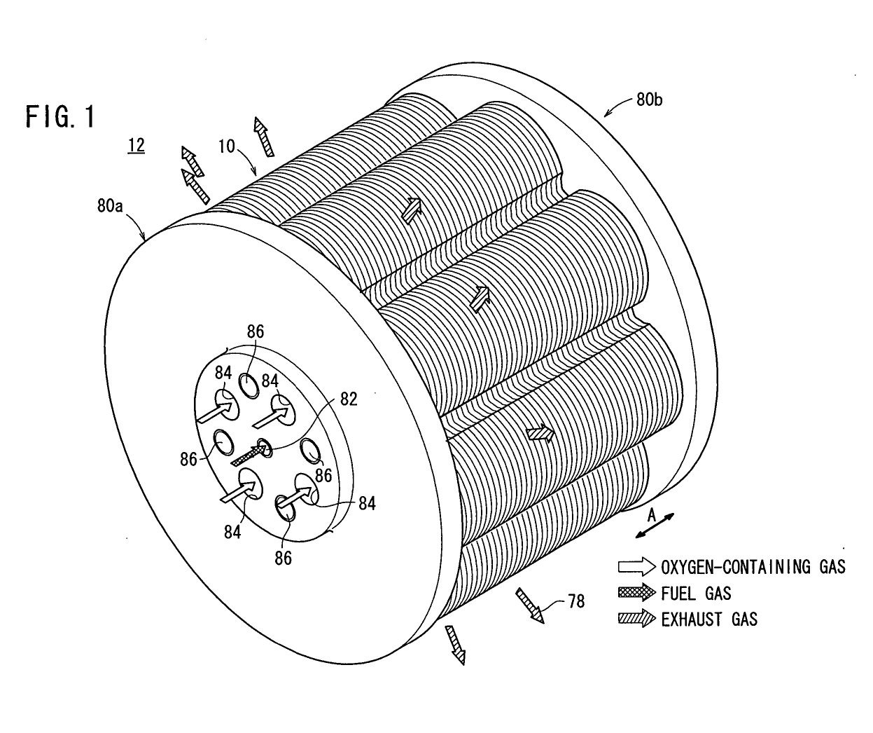

FIG. 1 is a perspective view schematically showing a fuel cell stack 12 formed by stacking fuel cells 10 according to a first embodiment according to the present invention in a direction indicated by an arrow A.

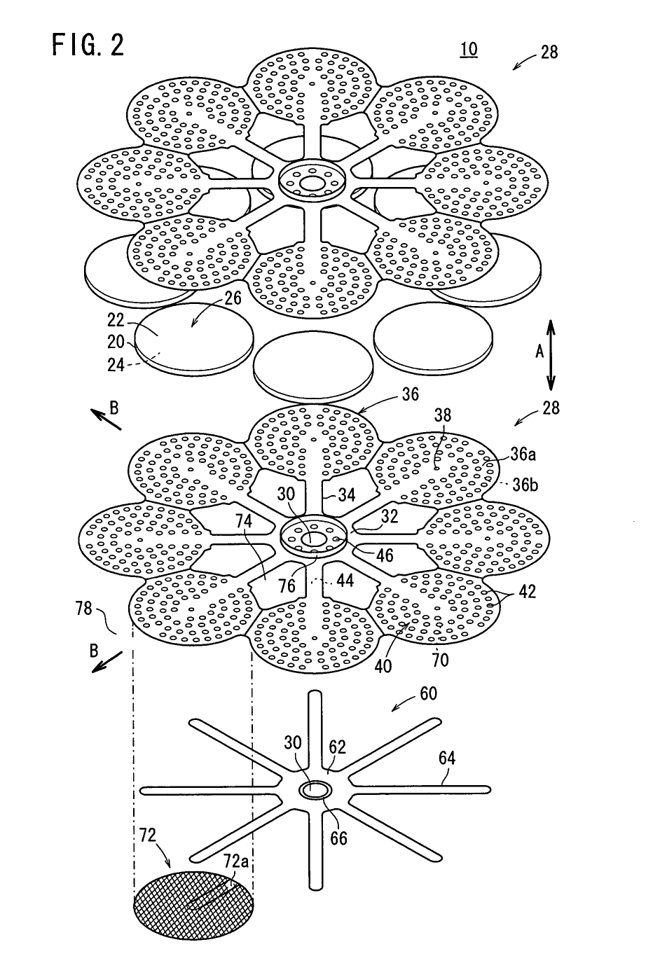

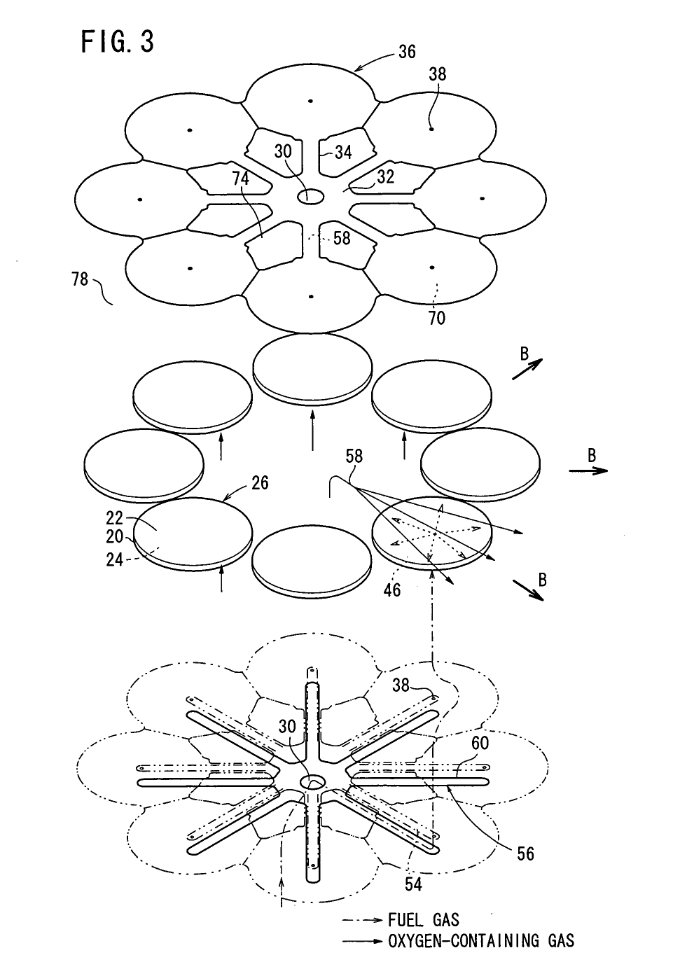

The fuel cell stack 12 is used in various applications, including stationary and mobile applications. For example, the fuel cell stack 12 is mounted on a vehicle. The fuel cell 10 is a solid oxide fuel cell (SOFC). As shown in FIGS. 2 and 3, the fuel cell 10 includes electrolyte electrode assemblies 26. Each of the electrolyte electrode assemblies 26 includes a cathode 22, an anode 24, and an electrolyte (electrolyte plate) 20 interposed between the cathode 22 and the anode 24. For example, the electrolyte 20 is made of ion-conductive solid oxide such as stabilized zirconia. A barrier layer (not shown) is provided at least at the outer circumferential edge of the electrolyte electrode assembly 26 for preventing the entry/emission of the oxygen-containing gas and the fuel gas.

A plurality of, e.g., eight electrolyte electrode assemblies 26 are sandwiched between a pair of separators 28 to form the fuel cell 10. The eight electrolyte electrode assemblies 26 are aligned along a virtual circle concentric with a fuel gas supply passage (fuel gas supply unit) 30 extending through the center of the separators 28.

In FIG. 2, for example, each of the separators 28 comprises a single metal plate of, e.g., stainless alloy or a carbon plate. The separator 28 has a first small diameter end portion 32. The fuel gas supply passage 30 extends through the center of the first small diameter end portion 32. The first small diameter end portion 32 is integral with circular disks 36 through a plurality of first bridges 34. The first bridges 34 extend radially outwardly from the first small diameter end portion 32 at equal angles (intervals).

The circular disk 36 and the electrolyte electrode assembly 26 have substantially the same size. A fuel gas inlet 38 for supplying the fuel gas is formed at the center of the circular disk 36, or at an upstream position deviated from the center of the circular disk 36 in the flow direction of the oxygen-containing gas.

Each of the circular disks 36 has a fuel gas channel 40 on its surface 36a which contacts the anode 24 for supplying a fuel gas along a surface of the anode 24. The fuel gas channel 40 is formed by a plurality of protrusions 42 on a surface 36a of each circular disk 36.

The protrusions 42 are solid portions formed by, e.g., etching on the surface 36a. Various shapes such as a rectangular shape, a circular shape, or a triangular shape can be adopted as the cross sectional shape of the protrusions 42. The positions or the density of the protrusions 42 can be changed arbitrarily depending on the flow state of the fuel gas or the like. Other protrusions as described later have the same structure as the structure of the protrusions 42.

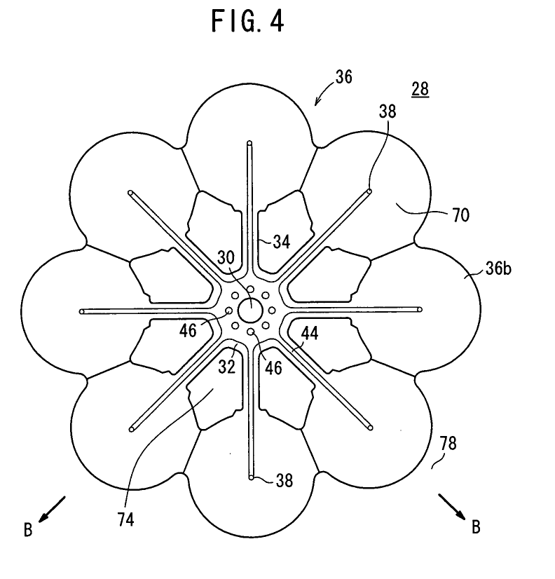

As shown in FIG. 4, each of the circular disks 36 has a substantially planar surface 36b which contacts the cathode 22. A fuel gas supply channel 44 extends from the first small diameter end portion 32 to the first bridge 34. The fuel gas supply channel 44 connects the fuel gas supply passage 30 to the fuel gas inlet 38. For example, the fuel gas supply channel 44 is formed by etching. A shown in FIGS. 2 and 4, the first small diameter end portion 32 has a plurality of holes 46 around the fuel gas supply passage 30.

As shown in FIG. 2, a channel member 60 is fixed to the separator 28 by, e.g., brazing or laser welding on a surface facing the cathode 22.

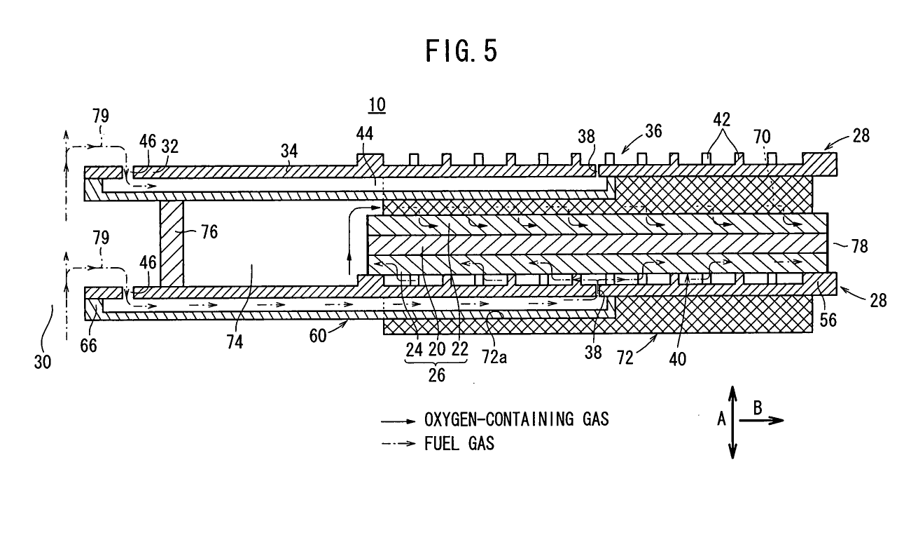

The channel member 60 has a planar shape, and includes a second small diameter end portion 62. The fuel gas supply passage 30 extends through the center of the second small diameter end portion 62. Eight second bridges 64 extend radially from the second small diameter end portion 62. Each of the second bridges 64 is fixed to the separator 28, from the first bridge 34 to the surface 36b of the circular disk 36, covering the fuel gas inlet 38 (see FIG. 5). The second small diameter end portion 62 has a ring shaped protrusion (second seal) 66 around the fuel gas supply passage 30. The protrusion 66 seals the fuel gas supply passage 30 from the fuel gas supply channel 44.

On the surface 36b of the circular disk 36, a deformable elastic channel member such as an electrically conductive mesh member 72 is provided. The elastically conductive mesh member 72 forms an oxygen-containing gas channel 70 for supplying an oxygen-containing gas along a surface of the cathode 22, and the electrically conductive mesh member 72 tightly contacts the cathode 22.

For example, the mesh member 72 is made of stainless steel wire rod (SUS material), and has a circular disk shape. The thickness of the mesh member 72 is determined such that the mesh member 72 is desirably deformed elastically when a load in the stacking direction indicated by the arrow A is applied to the mesh member 72. The mesh member 72 directly contacts the surface 36b of the circular disk 36, and has a cutout 72a as the space for providing the channel member 60 (see FIGS. 2 and 5).

As shown in FIG. 5, the area where the mesh member 72 is provided is smaller than the power generation area of the anode 24. The oxygen-containing gas channel 70 formed in the mesh member 72 is connected to the oxygen-containing gas supply passage (oxygen-containing gas supply unit) 74. The oxygen-containing gas is supplied in the direction indicated by the arrow B through the space between the inner circumferential edge of the electrolyte electrode assembly 26 and the inner circumferential edge of the circular disk 36. The oxygen-containing gas supply unit 74 extends inside the respective circular disks 36 between the first bridges 34 in the stacking direction indicated by the arrow A.

An insulating seal (first seal) 76 for sealing the fuel gas supply passage 30 is provided around the holes 46, between the separators 28. For example, the insulating seal 76 is made of mica material, or ceramic material. An exhaust gas channel 78 of the fuel cells 10 is formed outside the circular disks 36. The insulating seal 76 seals the fuel gas supply passage 30 from the electrolyte electrode assembly 26. The holes 46 are provided between the protrusion 66 and the insulating seal 76.

When the fuel cells 10 are stacked together, a branch channel 79 branched from the fuel gas supply passage 30 is formed between the separators 28. The branch channel 79 extends along the separator surface in the direction indicated by the arrow B. The branch channel 79 and the fuel gas supply channel 44 are connected by the holes 46 extending in the direction indicated by the arrow A.

As shown in FIG. 1, the fuel cell stack 12 includes end plates 80a, 80b provided at opposite ends of the fuel cells 10 in the stacking direction. The end plates 80a, 80b have a substantially circular disk shape. The end plate 80a has a hole 82 at a central position corresponding to the fuel gas supply passage 30, and a plurality of holes 84 corresponding to the oxygen-containing gas supply passage 74. Components between the end plates 80a, 80b are tightened together in the direction indicated by the arrow A by bolts (not shown) screwed into screw holes 86.

Next, operation of the fuel cell stack 12 will be described below.

As shown in FIG. 2, in assembling the fuel cell stack 12, firstly, the channel member 60 is joined to the surface of the separator 28 facing the cathode 22. Thus, the fuel gas supply channel 44 connected to the fuel gas supply passage 30 is formed between the separator 28 and the channel member 60. The fuel gas supply channel 44 is connected to the fuel gas channel 40 through the fuel gas inlet 38 (see FIG. 5).

At this time, the protrusion 66 of the channel member 60 are fixed to the first small diameter end portion 32 of the separator 28 to prevent direct connection between the fuel gas supply passage 30 and the fuel gas supply channel 44. That is, the fuel gas supply passage 30 is connected to the fuel gas supply channel 44 only through the holes 46.

Further, the ring shaped insulating seal 76 is provided on each of the separators 28 around the fuel gas supply passage 30. Thus, the fuel gas supply passage 30 is sealed from the electrolyte electrode assemblies 26, and the branch channel 79 branched from the fuel gas supply passage 30 is connected to the fuel gas supply channel 44 through the holes 46. Eight electrolyte electrode assemblies 26 are sandwiched between the separators 28 to form the fuel cell 10.

As shown in FIGS. 3 and 4, the electrolyte electrode assemblies 26 are interposed between the surface 36a of one separator 28 and the surface 36b of the other separator 28. The fuel gas inlet 38 is positioned at substantially the center in each of the anodes 24. The mesh member 72 is provided between the surface 36b of the separator 28 and the electrolyte electrode assembly 26. The cutout 72a of the mesh member 72 is provided at the position of the channel member 60.

A plurality of the fuel cells 10 are stacked in the direction indicated by the arrow A, and the end plates 80a, 80b are provided at opposite ends in the stacking direction to form the fuel cell stack 12.

As shown in FIG. 1, in the fuel cell stack 12, the fuel gas (hydrogen-containing gas) is supplied from the hole 82 of the end plate 80a into the fuel gas supply passage 30, and the oxygen-containing gas (hereinafter also referred to as the air) is supplied from the holes 84 of the end plate 80a to the oxygen-containing gas supply passage 74.

As shown in FIG. 5, the fuel gas flows in the stacking direction indicated by the arrow A along the fuel gas supply passage 30 of the fuel cell stack 12, and flows into the branch channel 79 in each of the fuel cells 10. Thus, the fuel gas flowing in the stacking direction is branched to flow along the separator surface in the direction indicated by the arrow B. Then, the fuel gas flows through the holes 46, and temporarily flows in the stacking direction, and the fuel gas flows through the fuel gas supply channel 44 connected to the holes 46 along the separator surface.

The fuel gas is supplied from the fuel gas supply channel 44 to the fuel gas inlet 38 formed in the circular disk 36 into the fuel gas channel 40. The fuel gas inlets 38 are formed at positions corresponding to substantially the central positions of the anodes 24 of the electrolyte electrode assemblies 26. Thus, the fuel gas is supplied from the fuel gas inlets 38 to substantially the central regions of the anodes 24, and flows outwardly from the central regions of the anodes 24 along the fuel gas channel 40.

The air supplied to the oxygen-containing gas supply passage 74 flows into the space between the inner circumferential edge of the electrolyte electrode assembly 26 and the inner circumferential edge of the circular disk 36 in the direction indicated by the arrow B, and flows toward the oxygen-containing gas channel 70 formed by the mesh member 72. In the oxygen-containing gas channel 70, the oxygen-containing gas flows from the inner circumferential edge (central region of the separator 28) to the outer circumferential edge (outer region of the separator 28), i.e., from one end to the other end of the cathode 22 of the electrolyte electrode assembly 26.

Thus, in the electrolyte electrode assembly 26, the fuel gas flows from the central region to the outer circumferential region of the anode 24, and the air flows in one direction indicted by the arrow B along the electrode surface of the cathode 22. At this time, oxygen ions flow through the electrolyte 20 toward the anode 24 for generating electricity by electrochemical reactions.

The air and the fuel gas used in the electrochemical reaction are discharged to the outside of the respective electrolyte electrode assemblies 26 and then flow through the exhaust gas channel 78 to the outside of the fuel cell stack 12 as an off gas (see FIG. 1).

In the first embodiment, as shown in FIG. 5, the fuel gas supply passage 30 extends in the stacking direction, and the branch channel 79 is branched from the fuel gas supply passage 30 in the direction indicated by the arrow B. The fuel gas supply channel 44 is connected to the fuel gas channel 40, and extends in the direction indicated by the arrow B. The branch channel 79 and the fuel gas supply channel 44 are connected through the holes 46. The holes 46 extend through the first small diameter end portion 32 of the separator 28 in the stacking direction.

In the structure, when a tightening load is applied to the fuel cell 10 in the stacking direction, it is possible to reliably supply the fuel gas to the anode 24 of each of the stacked electrolyte electrode assemblies 26 at a certain flow rate, without causing deformation of the holes 46. Thus, with simple and economical structure, uniform power generation reaction is achieved, and the power generation efficiency is improved.

In the channel member 60, the protrusion 66 is provided around the fuel gas supply passage 30. The protrusion 66 is fixed to the first small diameter end portion 32 to seal the fuel gas supply passage 30 from the fuel gas supply channel 44, and supports the load applied to the fuel cell 10 in stacking direction. Thus, it is possible to prevent deformation of the separator 28 and the channel member 60.

Further, in the first embodiment, the cathode 22 of the electrolyte electrode assembly 26 contacts the mesh member 72. In this state, the load in the stacking direction indicated by the arrow A is applied to the components of the fuel cell 10. Since the mesh member 72 is deformable, the mesh member 72 tightly contacts the cathode 22.

In the structure, the dimensional errors or distortions that occur at the time of production in the electrolyte electrode assembly 26 or the separator 28 can suitably be absorbed by elastic deformation of the mesh member 72. Thus, in the first embodiment, damage at the time of stacking the components of the fuel cell 10 is prevented. Since the components of the fuel cell 10 contact each other at many points, improvement in the performance of collecting electricity from the fuel cell 10 is achieved.

Further, in the first embodiment, the load in the stacking direction is efficiently transmitted through the protrusions 42 of the circular disk 36. Therefore, the fuel cells 10 can be stacked together with a small load, and distortion in the electrolyte electrode assemblies 26 and the separators 28 is reduced.

The protrusions 42 on the surface 36a of the circular disk 36 are formed by etching or the like as solid portions. Thus, the shape, the positions, and the density of the protrusions 42 can economically be changed arbitrarily and easily, e.g., depending on the flow state of the fuel gas, and the desired flow of the fuel gas is achieved. Further, since the protrusions 42 are formed as solid portions, the protrusions 42 are not deformed, and thus, the load is transmitted through the protrusions 42, and electricity is collected through the protrusions 42 efficiently.

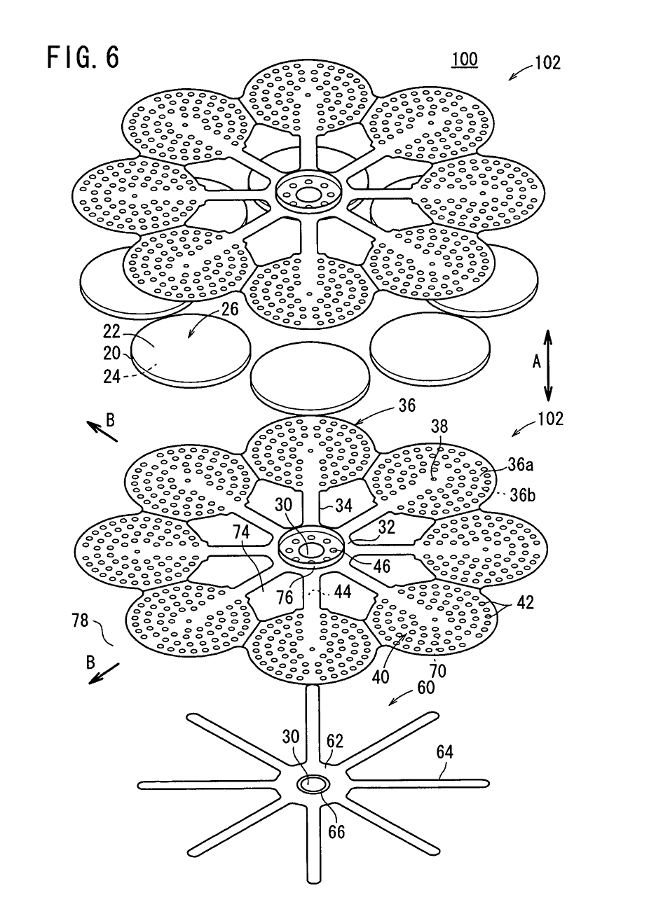

FIG. 6 is an exploded perspective view showing a fuel cell 100 according to a second embodiment of the present invention. The constituent elements that are identical to those of the fuel cell 10 according to the first embodiment are labeled with the same reference numeral, and description thereof will be omitted. Also in third to sixth embodiments as described later, the constituent elements that are identical to those of the fuel cell 10 according to the first embodiment are labeled with the same reference numeral, and description thereof will be omitted.

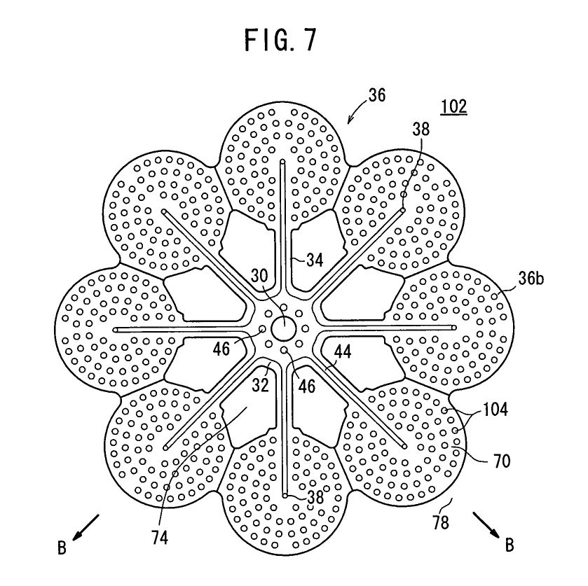

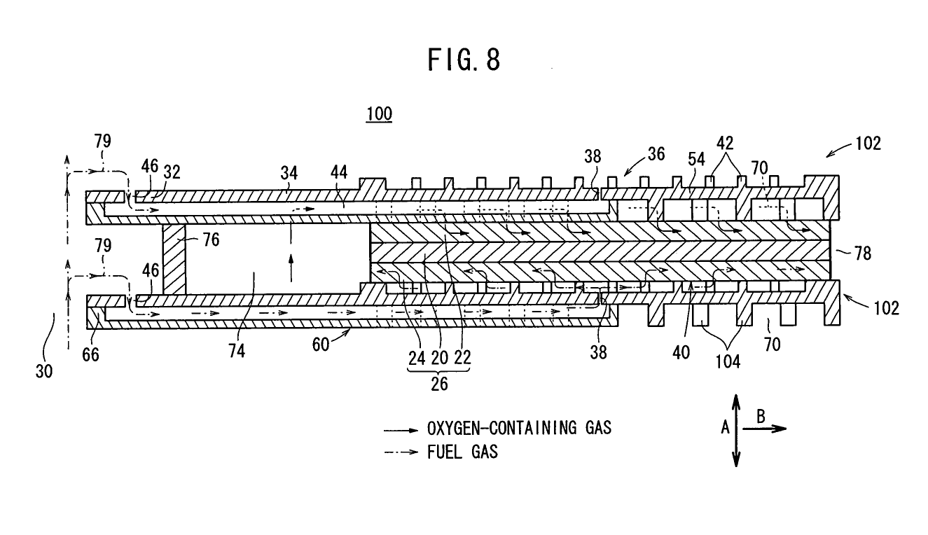

The fuel cell 100 includes a separator 102 having an oxygen-containing gas channel 70 on a surface facing the cathode 22. The oxygen-containing gas channel 70 comprises a plurality of protrusions 104 formed on a surface 36b of each circular disk 36 (see FIGS. 7 and 8). The protrusions 104 have the same structure as that of the protrusions 42.

In the second embodiment, the same advantages as in the case of the first embodiment can be obtained. For example, distortion of the electrolyte electrode assembly 26 and the separator 102 is reduced by the protrusions 104, and the uniform flow of the oxygen-containing gas is achieved.

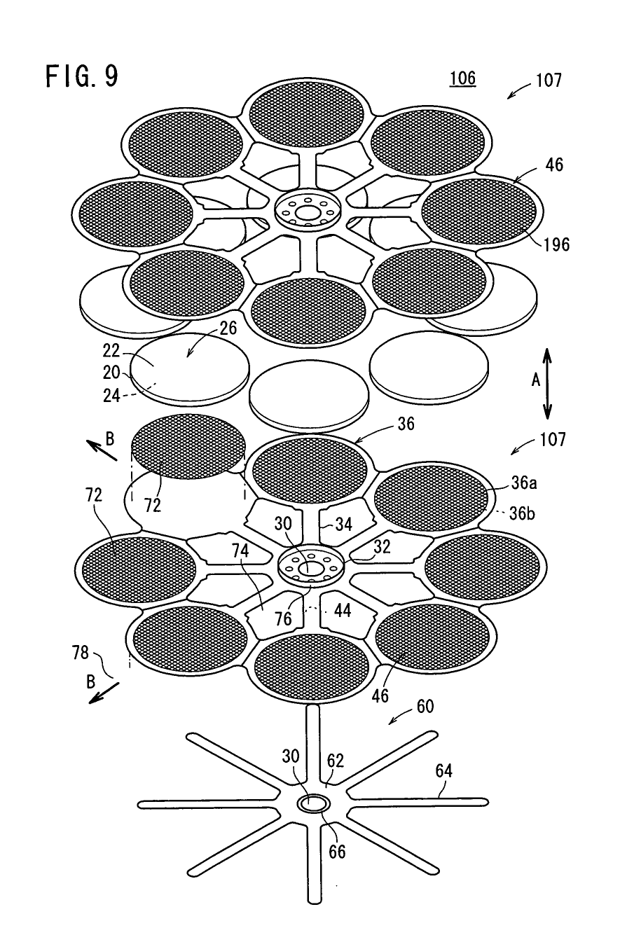

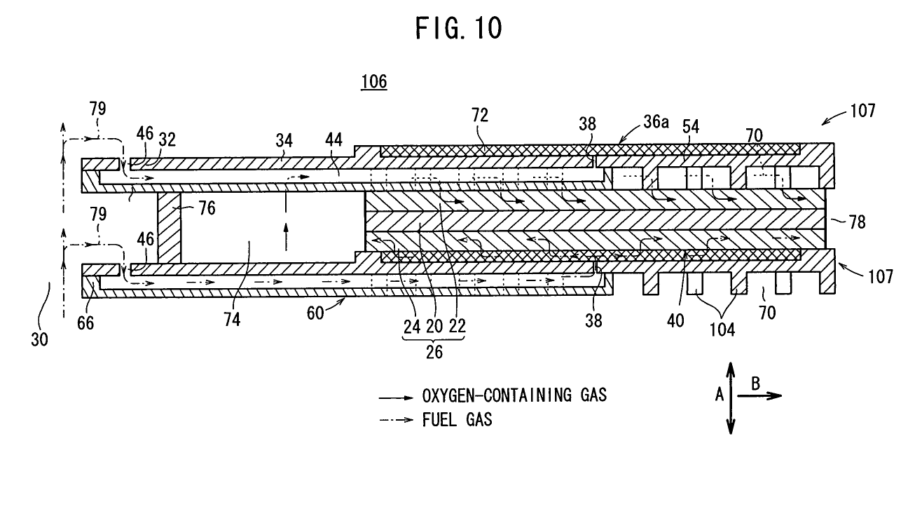

FIG. 9 is an exploded perspective showing a fuel cell 106 according to a third embodiment of the present invention. FIG. 10 is a cross sectional view showing operation of the fuel cell 106.

The fuel cell 106 includes a separator 107, and a deformable elastic channel member such as an electrically conductive mesh member 72 is provided on a surface 36a of the circular disk 36 of the separator 107. The electrically conductive mesh member 72 forms a fuel gas channel 40 for supplying the fuel gas along a surface of the anode 24, and tightly contacts the anode 24 (see FIGS. 9 and 10).

In the third embodiment, by deformation of the mesh member 72, the mesh member 72 tightly contacts the anode 24.

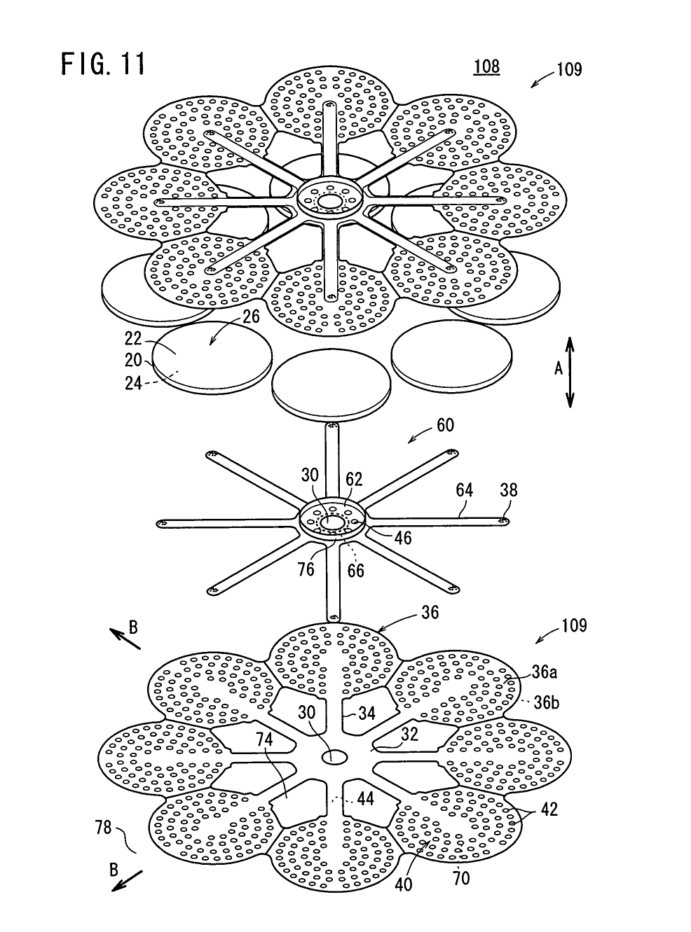

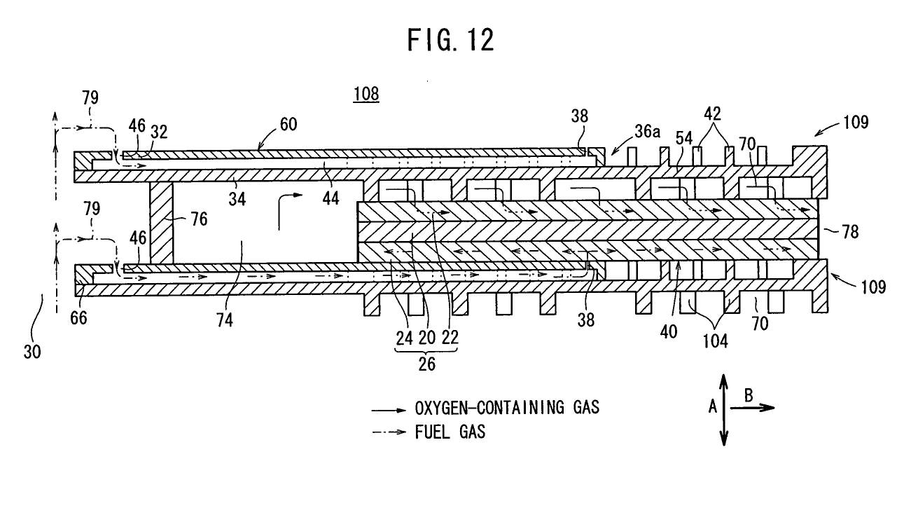

FIG. 11 is an exploded perspective view showing a fuel cell 108 according to a fourth embodiment of the present invention. FIG. 12 is a cross sectional view showing operation of the fuel cell 108.

The fuel cell 108 includes a separator 109, and the channel member 60 is fixed to a surface of the separator 109 facing the anode 24. A plurality of fuel gas inlets 38 are formed at each of the front ends of the second bridges 64 of the channel member 60, and the holes 46 are provided around the fuel gas supply passage 30 in the second small diameter end portion 62 of the channel member 60. No fuel gas inlets are provided in the circular disk 36.

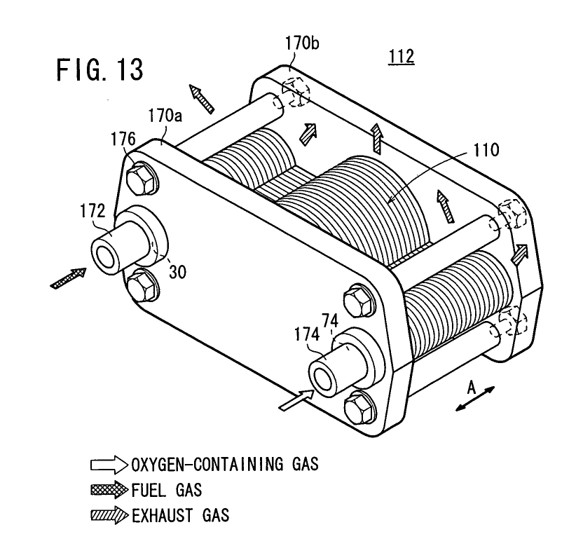

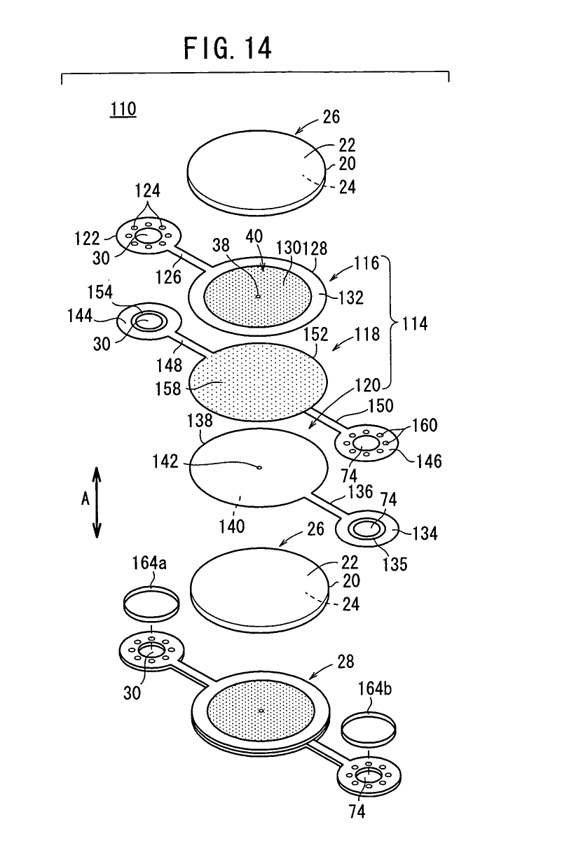

FIG. 13 is a perspective view schematically showing a fuel cell stack 112 formed by stacking a plurality of fuel cells 110 according to a fifth embodiment of the present invention in a direction indicated by an arrow A. FIG. 14 is an exploded perspective view showing the fuel cell 110.

The fuel cell 110 is formed by sandwiching the electrolyte electrode assembly 26 between a pair of separators 114. Each of the separators 114 includes a first plate 116, a second plate 118, and a third plate 120. For example, the first to third plates 116, 118, 120 are metal plates of, e.g., stainless alloy. The first plate 116 and the third plate 120 are joined to both surfaces of the second plate 118 by brazing, for example.

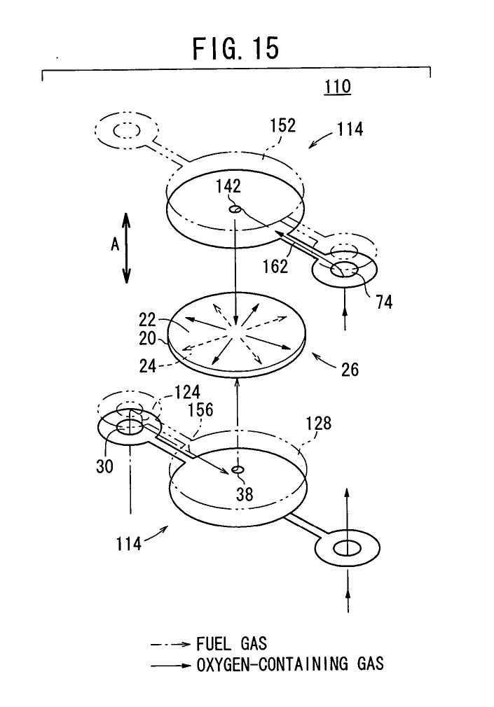

As shown in FIGS. 14 and 15, the first plate 116 has a first small diameter end portion 122. A fuel gas supply passage 30 for supplying a fuel gas in the stacking direction indicated by the arrow A extends through the first small diameter end portion 122. The first small diameter end portion 122 has a plurality of holes 124 around the fuel gas supply passage 30. The first small diameter end portion 122 is integral with a first circular disk 128 having a relatively large diameter through a narrow bridge 126. The first circular disk 128 and the anode 24 of the electrolyte electrode assembly 26 have substantially the same size.

A large number of first protrusions 130 are formed on a surface of the first circular disk 128 which contacts the anode 24, in a central region adjacent to an outer circumferential region. A substantially ring shaped protrusion 132 is provided on the outer circumferential region of the first circular disk 128. The first protrusions 130 and the substantially ring shaped protrusion 132 jointly function as a current collector.

A fuel gas inlet 38 is provided at the center of the first circular disk 128 for supplying the fuel gas toward substantially the central region of the anode 24. The first protrusions 130 may be formed by making a plurality of recesses in a surface which is in the same plane with the surface of the substantially ring shaped protrusion 132.

The third plate 120 has a second small diameter end portion 134. An oxygen-containing gas supply passage 74 for supplying an oxygen-containing gas in the direction indicated by the arrow A extends through the third plate 120. The second small diameter end portion 134 has a ring shaped protrusion (second seal) 135 around the oxygen-containing gas supply passage 74. The second small diameter end portion 134 is integral with a second circular disk 138 having a relatively large diameter through a narrow bridge 136.

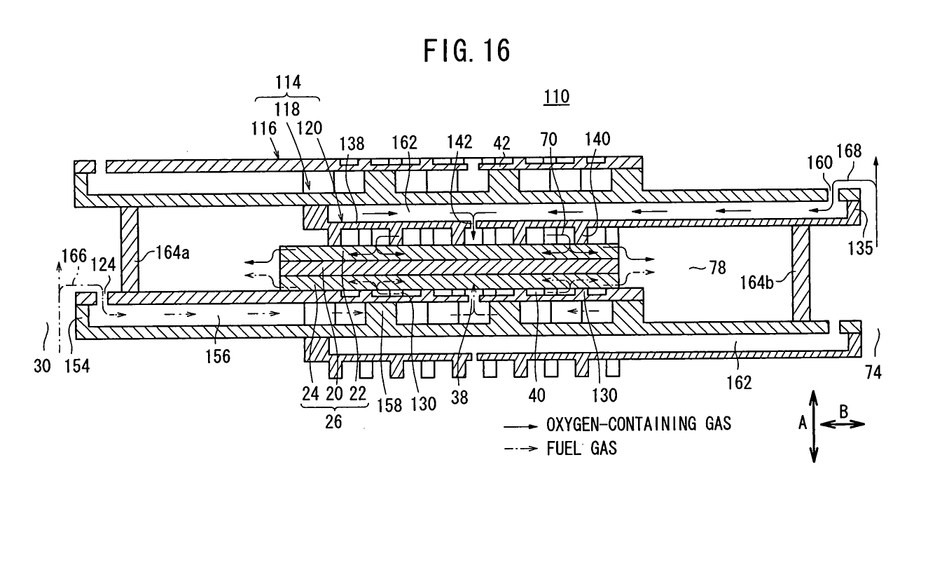

A plurality of second protrusions 140 as part of the oxygen-containing gas channel 70 are formed in the entire surface of the second circular disk 138 which contacts the cathode 22 of the electrolyte electrode assembly 26 (see FIG. 16). The second protrusions 140 form a current collector. An oxygen-containing gas inlet 142 is provided at the center of the second circular disk 138 for supplying the oxygen-containing gas toward substantially the central region of the cathode 22.

As shown in FIG. 14, the second plate 118 includes a third small diameter end portion 144 and a fourth small diameter end portion 146. The fuel gas supply passage 30 extends through the third small diameter end portion 144, and the oxygen-containing gas supply passage 74 extends through the fourth small diameter end portion 146. The third and fourth small diameter end portions 144, 146 are integral with a third circular disk 152 having a relatively large diameter through narrow bridges 148, 150, respectively. The first to third circular disks 128, 138, 152 have the same diameter.

A ring shaped protrusion (second seal) 154 is formed around the fuel gas supply passage 30. A fuel gas supply channel 156 connected to the fuel gas inlet 38 is provided between the bridges 126, 148 (see FIG. 16). The third circular disk 152 has a plurality of third protrusions 158, and the third protrusions 158 form part of the fuel gas supply channel 156.

The fourth small diameter end portion 146 has a plurality of holes 160 around the oxygen-containing gas supply passage 74. An oxygen-containing gas supply channel 162 connected to an oxygen-containing gas inlet 142 is formed between bridges 136, 150 (see FIG. 16).

The first plate 116 is joined to the second plate 118 by brazing to form the fuel gas supply channel 156 connected to the fuel gas supply channel 40 between the first and second plates 116, 118. Likewise, the second plate 118 is joined to the third plate 120 by brazing to form an oxygen-containing supply channel 162 connected to the oxygen-containing gas channel 70 between the second and third plates 118, 120.

An insulating seal (first seal) 164a and an insulating seal (first seal) 164b are provided between the separators 28. The insulating seal 164a is provided around the holes 124 for sealing the fuel gas supply passage 30, and the insulating seal 164b is provided around the holes 160 for sealing the oxygen-containing gas supply passage 74. For example, the insulating seals 164a, 164b are made of mica material, or ceramic material.

As shown in FIG. 16, in the presence of the insulating seal 164a, a branch channel 166 branched from the fuel gas supply passage 30 in the direction indicated by the arrow B is connected to the fuel gas supply channel 156 through the holes 124. Likewise, in the presence of the insulating seal 164b, a branch channel 168 branched from the oxygen-containing gas supply passage 74 is connected to the oxygen-containing gas supply channel 162 through the holes 160.

As shown in FIG. 13, the fuel cell stack 112 includes end plates 170a, 170b provided at opposite ends of the fuel cells 110 in the stacking direction. A first pipe 172 and a second pipe 174 extend through the end plate 170a. The first pipe 172 is connected to the fuel gas supply passage 30 of the fuel cells 110, and the second pipe 174 is connected to the oxygen-containing gas supply passage 74 of the fuel cells 110. Tightening bolts 176 tighten the end plate 170a and the end plate 170b, while the end plate 170a or the end plate 170b is electrically insulated from the tightening bolts 176.

Next, operation of the fuel cell stack 112 will be described blow.

In the fuel cell stack 112, a fuel gas is supplied to the first pipe 172 connected to the end plate 170a, and the fuel gas flows from the first pipe 172 to the fuel gas supply passage 30. An oxygen-containing gas (hereinafter referred to as the air) is supplied to the second pipe 174 connected to the end plate 170a, and the air flows from the second pipe 174 to the oxygen-containing gas supply passage 74 (see FIG. 13).

As shown in FIG. 16, after the fuel gas flows into the fuel gas supply passage 30, the fuel gas flows in the stacking direction indicated by the arrow A, and is branched into the branch channel 166 for each of the fuel cells 110. Then, the fuel gas flows through the holes 124 into the fuel gas supply channel 156. The fuel gas is supplied from the fuel gas supply channel 156 to the fuel gas channel 40 through the fuel gas inlet 38.

The oxygen-containing gas supplied to the oxygen-containing gas supply passage 74 flows in the stacking direction, and is branched into the branch channel 168 for each of the fuel cells 110. Then, the oxygen-containing gas flows through the holes 160 into the oxygen-containing gas supply channel 162. The oxygen-containing gas is supplied from the oxygen-containing gas inlet 142 connected to the oxygen-containing gas supply channel 162, and flows into the oxygen-containing gas channel 70.

Thus, in each of the electrolyte electrode assemblies 26, the fuel gas is supplied from the central region of the anode 24 to the outer circumferential region of the anode 24, and the oxygen-containing gas is supplied from the central region of the cathode 22 to the outer circumferential region of the cathode 22 for generating electricity. After the fuel gas and the air are consumed in the power generation, the fuel gas and the oxygen-containing gas are discharged as an exhaust gas into the exhaust gas channel 78 from the outer circumferential portions of the first to third circular disks 128, 152, and 138.

In the fifth embodiment, as shown in FIG. 16, the branch channel 168 branched from the oxygen-containing gas supply passage 74 and the oxygen-containing gas supply channel 162 connected to the oxygen-containing gas channel 70 are connected through the holes 160, and the holes 160 extend through the second plate 118 in the stacking direction.

Therefore, when a tightening force is applied to the fuel cells 110 in the stacking direction, the oxygen-containing gas is reliably supplied to the cathode 22 without causing deformation of the holes 160.

Likewise, the branch channel 166 branched from the fuel gas supply passage 30 and the fuel gas supply channel 156 connected to the fuel gas channel 40 are connected to the holes 124, and the holes 124 extend through the first plate 116 in the stacking direction. Therefore, it is possible to reliably supply the fuel gas to the anode 24, while effectively preventing deformation of the holes 124. Accordingly, the same advantages as in the cases of the first to fourth embodiments can be obtained. For example, with simple structure, uniform power generation reaction is achieved, and the power generation efficiency is improved.

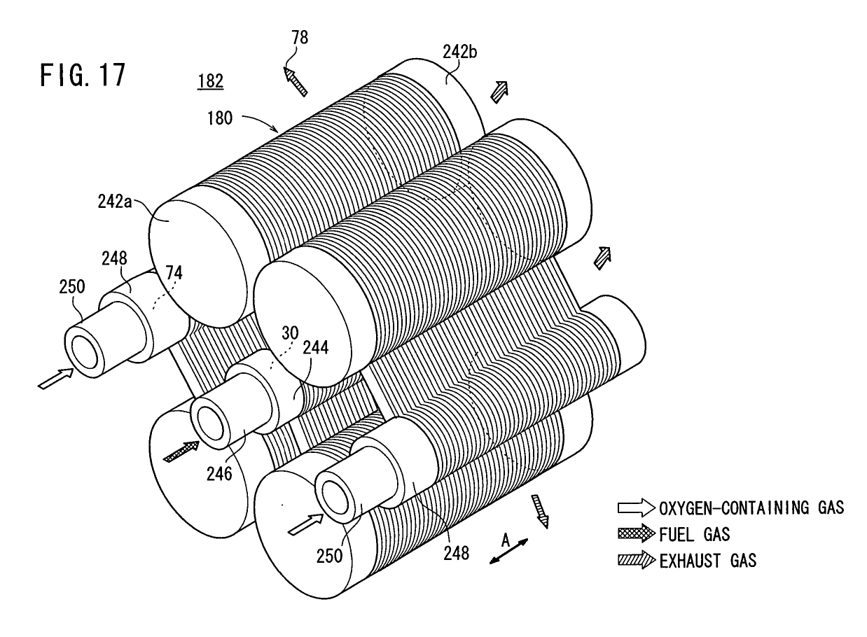

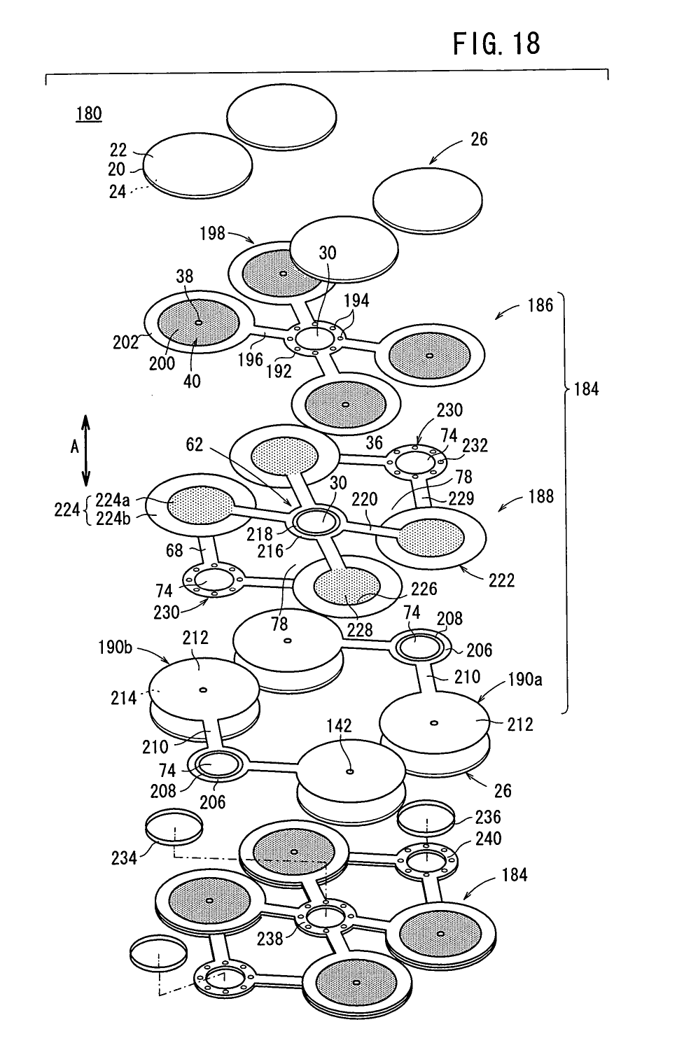

FIG. 17 is a perspective view schematically showing a fuel cell stack 182 formed by stacking fuel cells 180 according to a sixth embodiment in the direction indicated by the arrow A. FIG. 18 is an exploded perspective view showing the fuel cell 180.

As shown in FIG. 18, the fuel cell 180 is formed by sandwiching four electrolyte electrode assemblies 26 between a pair of separators 184. The separator 184 includes a first plate 186, a second plate 188, and a pair of third plates 190a, 190b. For example, the first to third plates 186, 188, 190a, 190b are metal plates of, e.g., stainless alloy. The first plate 186 and the third plates 190a, 190b are joined to both surfaces of the second plate 188 by brazing, for example.

The first plate 186 has a first small diameter end portion 192, and the first small diameter end portion 192 has a plurality of holes 194 around the fuel gas supply passage 30. The first small diameter end portion 192 is integral with four first circular disks 198 each having a relatively large diameter through narrow bridges 196.

A large number of first protrusions 200 are formed on a surface of the first circular disk 198 which contacts the anode 24, in a central region adjacent to an outer circumferential region. A substantially ring shaped protrusion 202 is provided in the outer circumferential region of the first circular disk 198. The first protrusions 200 and the substantially ring shaped protrusion 202 jointly form a current collector.

A fuel gas inlet 38 is provided at the center of the first circular disk 198 for supplying the fuel gas toward substantially the central region of the anode 24.

Each of the third plates 190a, 190b has a second small diameter end portion 206. The oxygen-containing gas supply passage 74 extends through the second small diameter end portion 206, and a ring-shaped protrusion (second seal) 208 is provided around the oxygen-containing gas supply passage 74. The second small diameter end portion 206 is integral with two second circular disks 212 each having a relatively large diameter through two narrow bridges 210.

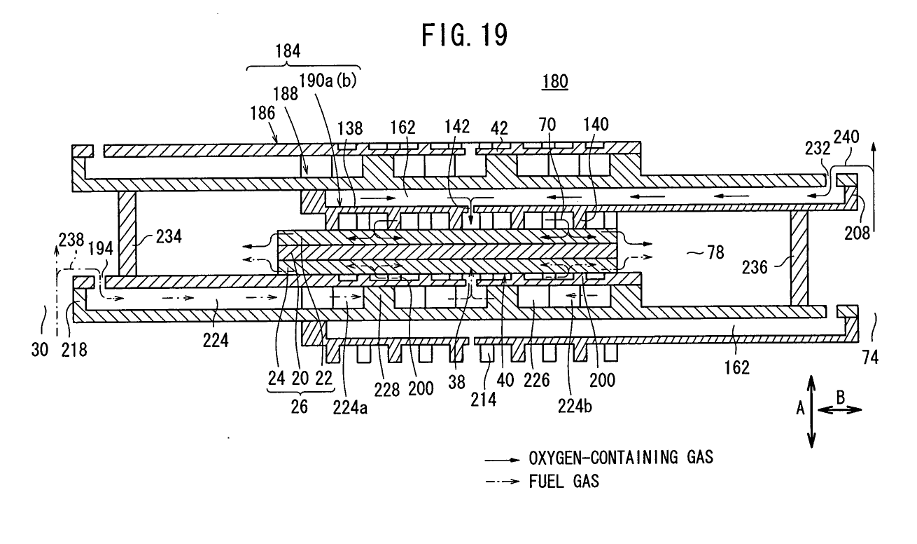

As shown in FIG. 19, a plurality of second protrusions 214 are formed on the entire surface of the second circular disk 212 which contacts the cathode 22 of the electrolyte electrode assembly 26. The second protrusions 214 form a current collector. An oxygen-containing gas inlet 142 is provided at the center of the second circular disk 212 for supplying the oxygen-containing gas toward substantially the central region of the cathode 22.

The second plate 188 includes a third small diameter end portion 216. The fuel gas supply passage 30 extends through the third small diameter end portion 216, and the third small diameter end portion 216 has a ring shaped protrusion (second seal) 218 around the fuel gas supply passage 30. The third small diameter end portion 216 is integral with four third circular disks 222 each having a relatively large diameter through four narrow bridges 220.

The third circular disks 222 have fuel gas supply channels 224, respectively. Each of the fuel gas supply channels 224 is divided into first and second fuel gas channel units 224a, 224b through a partition 226 formed by a substantially ring shaped ridge. A plurality of third protrusions 228 are provided inside the partition 226.

The four third circular disks 222 are integral with two fourth small diameter end portions 230. Each of the fourth small diameter end portion 230 is connected to the third circular disks 222 thorough two narrow bridges 229. The fourth small diameter end portion 230 has a plurality of holes 232 around the oxygen-containing gas supply passage 74.

Insulating seals (first seals) 234, 236 are provided around the fuel gas supply passage 30 and the oxygen-containing gas supply passage 74 between the separators 184. A branch channel 238 branched from the fuel gas supply passage 30 is formed inside the insulating seal 234, and a branch channel 240 branched from the oxygen-containing gas supply passage 74 is formed inside the insulating seal 236.

As shown in FIG. 17, in the fuel cell stack 182, four end plates 242a, 242b are provided at each of opposite ends of the fuel cells 180. A plate 244 is provided at each of opposite ends of the fuel gas supply passage 30 in the direction indicated by the arrow A, and a first pipe 246 for supplying the fuel gas to the fuel gas supply passage 30 is connected to the plate 244.

Two plates 248 are provided at each of the opposite ends of the oxygen-containing gas supply passages 74 in the direction indicated by the arrow A. The plates 248 are connected to the second pipes 250 for supplying the air to the oxygen-containing gas supply passages 74. The plates 244 and the plates 248 at opposite ends in the stacking direction indicated by the arrow A are fixed by tightening bolts (not shown).

In the sixth embodiment, as shown in FIG. 17, the fuel gas is supplied to the fuel gas supply passage 30 in the fuel cell stack 182 through the first pipe 246, and the air is supplied to the oxygen-containing gas supply passages 74 in the fuel cell stack 182 through the second pipes 250.

As shown in FIG. 19, the fuel gas supplied to the fuel gas supply passage 30 flows in the stacking direction, and branched into the branch channel 238 between the separators 184 of each of the fuel cells 180. Then, the fuel gas is supplied to the respective fuel gas supply channels 224 through the holes 194. The fuel gas flows into the first fuel gas supply units 224a through the fuel gas supply channels 224.

Thus, the fuel gas supplied to the first fuel gas supply channel units 224a flows toward the central positions of the anodes 24 of the electrolyte electrode assemblies 26 through the fuel gas inlets 38.

The air supplied to the two oxygen-containing gas supply passages 74 is branched into the branch channels 240 between the separators 184, and flows through the oxygen-containing gas supply channels 162 through the holes 232. Then, the air flows toward the central positions of the cathodes 22 of the electrolyte electrode assemblies 26 through the oxygen-containing gas inlets 142 provided at the center of the second circular disk 212.

In the sixth embodiment, the same advantages as in the cases of the first to fifth embodiments can be obtained.

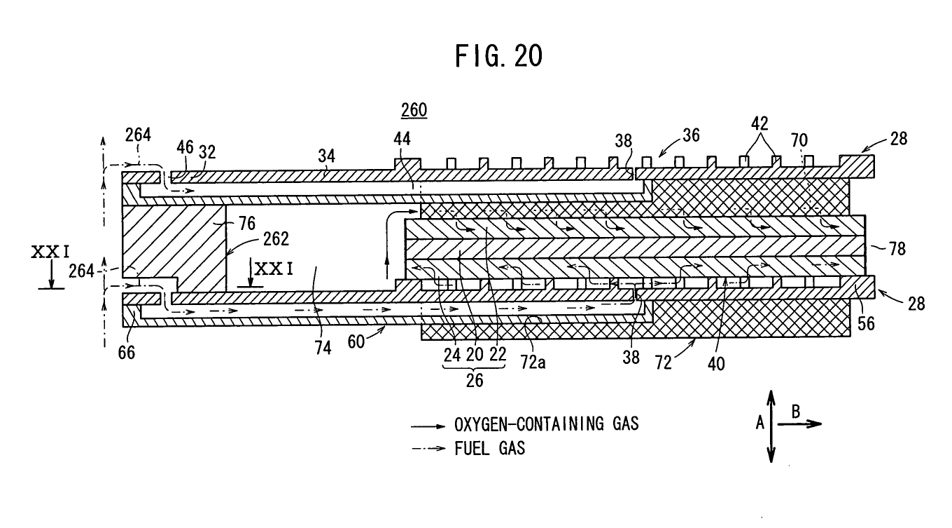

FIG. 20 is a cross sectional view showing operation of a fuel cell 260 according to a seventh embodiment of the present invention. The constituent elements that are identical to those of the fuel cell 10 according to the first embodiment are labeled with the same reference numeral, and description thereof will be omitted.

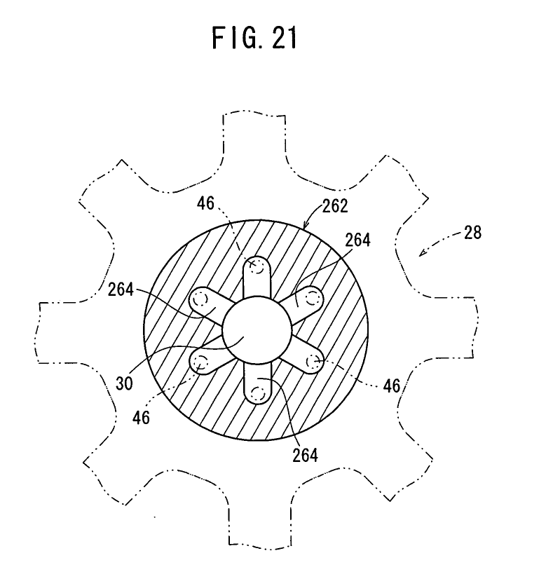

The fuel cell 260 includes an insulating seal (first seal) 262 provided between the separators 28 to cover holes 46. The fuel gas supply passage 30 is formed at the center of the insulating seal 262. Branch channels 264 are provided inside the insulating seal 262, and branched outwardly from the fuel gas supply passage 30. The branch channels 264 are connected to eight holes 46. The holes 46 are connected to the fuel gas supply passage 30 through the branch channels 264 (see FIG. 21).

In the seventh embodiment, the same advantages as in the case of the first embodiment can be obtained.

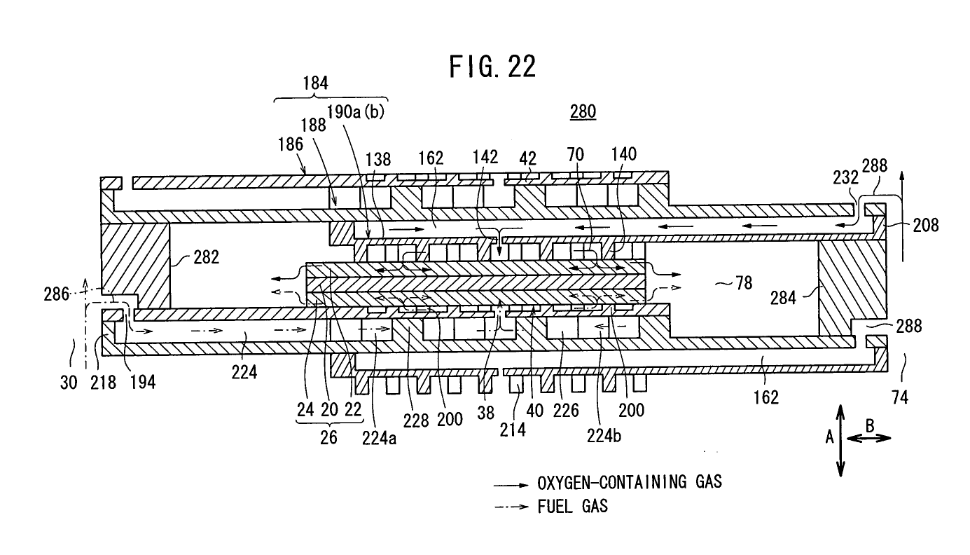

FIG. 22 is a cross sectional view showing operation of a fuel cell 260 according to an eighth embodiment of the present invention. The constituent elements that are identical to those of the fuel cell 180 according to the sixth embodiment are labeled with the same reference numeral, and description thereof will be omitted.

The fuel cell 260 includes insulating seals (first seals) 282, 284 provided between separators 184 to cover holes 194, 232. The fuel gas supply passage 30 is formed at the center of the insulating seal 282. A branch channel 286 is provided inside the insulating seal 282, and branched outwardly from the fuel gas supply passage 30. The oxygen-containing gas supply passage 74 is formed at the center of the insulating seal 284. A branch channel 288 is formed inside the insulating seal 284, and branched outwardly from the oxygen-containing gas supply passage 74.

Thus, in the eighth embodiment, the same advantages as in the case of the sixth embodiment can be obtained.

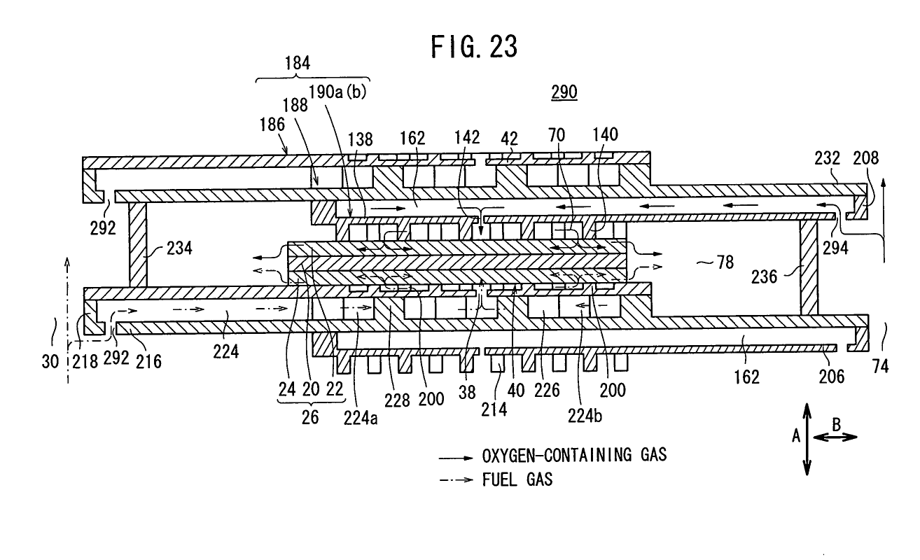

FIG. 23 is a cross sectional view schematically showing operation of a fuel cell 290 according to a ninth embodiment of the present invention. The constituent elements that are identical to those of the fuel cell 180 according to the sixth embodiment are labeled with the same reference numeral, and description thereof will be omitted.

The fuel cell 290 includes a plurality of holes 292 in the third small diameter end portion 216 of the second plate 188 around the fuel gas supply passage 30, and a plurality of holes 294 in the second small diameter end portion 206 of each of the third plates 190a, 190b around the oxygen-containing gas supply passage 74.

Thus, in the ninth embodiment, the same advantages as in the case of the sixth embodiment can be obtained.

While the invention has been particularly shown and described with reference to preferred embodiments, it will be understood that variations and modifications can be effected thereto by those skilled in the art without departing from the spirit and scope of the invention as defined by the appended claims.

What is claimed is:

1. A fuel cell formed by stacking an electrolyte electrode assembly and a separator, said electrolyte electrode assembly including an anode, a cathode, and an electrolyte interposed between said anode and said cathode, said fuel cell comprising:
a fuel gas channel provided on one surface of said separator for supplying a fuel gas along a surface of said anode;
an oxygen-containing gas channel provided on the other surface of said separator for supplying an oxygen-containing gas along a surface of said cathode;
a fuel gas supply channel for supplying the fuel gas from a fuel gas supply unit which allows the fuel gas to flow in a stacking direction, to said fuel gas channel, said fuel gas supply channel extending along a separator surface to intersect the stacking direction;
a branch channel branched from said fuel gas supply unit toward the separator surface; and
a hole connecting said branch channel and said fuel gas supply channel in the stacking direction.

2. A fuel cell formed by stacking an electrolyte electrode assembly and a separator, said electrolyte electrode assembly including an anode, a cathode, and an electrolyte interposed between said anode and said cathode, said fuel cell comprising:
a fuel gas channel provided on one surface of said separator for supplying a fuel gas along a surface of said anode;
an oxygen-containing gas channel provided on the other surface of said separator for supplying an oxygen-containing gas along a surface of said cathode;
an oxygen-containing gas supply channel for supplying the oxygen-containing gas from an oxygen-containing gas supply unit which allows the oxygen-containing gas to flow in a stacking direction, to said oxygen-containing gas channel, said oxygen-containing gas supply channel extending along a separator surface to intersect the stacking direction;
a branch channel branched from said oxygen-containing gas supply unit toward the separator surface; and
a hole connecting said branch channel and said oxygen-containing gas supply channel in the stacking direction.

3. A fuel cell formed by stacking an electrolyte electrode assembly and a separator, said electrolyte electrode assembly including an anode, a cathode, and an electrolyte interposed between said anode and said cathode, said fuel cell comprising:
a fuel gas channel provided on one surface of said separator for supplying a fuel gas along a surface of said anode;
an oxygen-containing gas channel provided on the other surface of said separator for supplying an oxygen-containing gas along a surface of said cathode;
a fuel gas supply channel for supplying the fuel gas from a fuel gas supply unit which allows the fuel gas to flow in a stacking direction, to said fuel gas channel, said fuel gas supply channel extending along a separator surface to intersect the stacking direction;
an oxygen-containing gas supply channel for supplying the oxygen-containing gas from an oxygen-containing gas supply unit which allows the oxygen-containing gas to flow in a stacking direction, to said oxygen-containing gas channel, said oxygen-containing gas supply channel extending along a separator surface to intersect the stacking direction;
a branch channel branched from said fuel gas supply unit toward the separator surface;
a fuel gas hole connecting said branch channel and said fuel gas supply channel in the stacking direction;
a branch channel branched from said oxygen-containing gas supply unit toward the separator surface; and
an oxygen-containing gas hole connecting said branch channel and said oxygen-containing gas supply channel in the stacking direction.

4. A fuel cell according to claim 1, wherein a first seal is provided at said branch channel around said hole for sealing said fuel gas supply unit from said electrolyte electrode assembly.

5. A fuel cell according to claim 4, wherein a second seal is provided for sealing said fuel gas supply unit from said fuel gas supply channel; and
said hole is provided between said first seal and said second seal.

6. A fuel cell according to claim 4, wherein a second seal is provided for sealing said fuel gas supply unit from said fuel gas supply channel; and
said branch channel is formed in said first seal.

7. A fuel cell according to claim 2, wherein a first seal is provided at said branch channel around said hole for sealing said oxygen-containing gas supply unit from said electrolyte electrode assembly.

8. A fuel cell according to claim 7, wherein a second seal is provided for sealing said oxygen-containing gas supply unit from said oxygen-containing gas supply channel; and
said hole is provided between said first seal and said second seal.

9. A fuel cell according to claim 7, wherein a second seal is provided for sealing said oxygen-containing gas supply unit from said oxygen-containing gas supply channel; and
said branch channel is formed in said first seal.

10. A fuel cell according to claim 1, wherein first protrusions forming said fuel gas channel or a deformable elastic channel member forming said fuel gas channel, and tightly contacting said anode is formed on one surface of said separator; and
a fuel gas channel member forming said fuel gas supply channel is provided on the one surface or the other surface of said separator.

11. A fuel cell according to claim 2, wherein second protrusions forming said oxygen-containing gas channel or a deformable elastic channel member forming said oxygen-containing gas channel, and tightly contacting said cathode is formed on the other surface of said separator.

12. A fuel cell according to claim 3, wherein first protrusions forming said fuel gas channel or a deformable elastic channel member forming said fuel gas channel, and tightly contacting said anode is formed on one surface of said separator;
second protrusions forming said oxygen-containing gas channel or a deformable elastic channel member forming said oxygen-containing gas channel, and tightly contacting said cathode is formed on the other surface of said separator; and
a fuel gas channel member forming said fuel gas supply channel is provided on one surface or the other surface of said separator.

13. A fuel cell according to claim 10, wherein said separator comprises a single plate; and
said fuel cell further comprises a seal member provided between a pair of said separators and a protrusion provided in said separator or said fuel gas channel member.

14. A fuel cell according to claim 13, wherein said hole is formed in said separator or said fuel gas channel member.

15. A fuel cell according to claim 12, wherein said separator includes first to third plates which are stacked together;
said fuel gas channel is formed between said first plate and said anode, and said oxygen-containing gas channel is formed between said third plate and said cathode; and
said fuel gas supply channel is formed between said first plate and said second plate, and said oxygen-containing gas supply channel is formed between said third plate and said second plate.

16. A fuel cell according to claim 15, wherein a fuel gas hole is formed in said first plate or said second plate; and
said fuel cell further comprises a second seal provided in said first plate or said second plate.

17. A fuel cell according to claim 15, wherein an oxygen-containing gas hole is formed in said second plate or said third plate; and
said fuel cell further comprises a second seal provided in said second plate or said third plate.
